(19) United States
(12) Patent Application Publication
(10) Pub. No.: US 2003/0028774 A1
(43) Pub. Date: Feb. 6, 2003

(54) Ensuring the integrity of an electronic document

(76) Inventor: Anil Kumar Meka, Andhra Pradesh (IN)

Correspondence Address: NARENDRA R. THAPPETA, LANDON & STARK ASSOCIATES, ONE CRYSTAL PARK, SUITE 210, 2011 CRYSTAL DRIVE, ARLINGTON, VA, 22202, US

(21) Appl. No.: 09/921,995

(22) Filed: Aug. 6, 2001

(51) Int. Cl. H04L 9/00

(52) U.S. Cl. 713/176

(57) ABSTRACT

Two digital signatures are generated associated with an electronic document. One digital signature (“content signature”) maybe based on a user input contained in the document and another digital signature (“document signature”) may be based on a stream of data representing the document. The document is sent along with the two signatures to a receiver system. The receiver system can verify the integrity of the document (and thus the user input) based on one or both of the signatures. Optionally, multiple content signatures may be used with each content signature being generated based on a portion of a document. In addition, each document may contain a control section which includes rules specifying permitted/prohibited actions against each portion.

### BACKGROUND OF THE INVENTION

1. Field of the Invention

The present invention relates to interchange of electronic documents and more specifically to a method and apparatus for ensuring the integrity of such documents when transmitted from one person to another.

2. Related Art

Electronic documents (“documents”) are often exchanged between people over electronic media such as Internet, dial-up modems, etc. In a typical transaction, a sender includes a desired content (“user input”) into an electronic file, provides a signature to generate a document, and sends the document to a receiver. Example scenarios where documents are exchanged include, but not limited to, sending invoices, sending electronic files generated by word-processors, etc.

There is often a need to ensure the integrity of documents. Ensuring integrity generally implies that a receiver can be certain that the content of a document has not been altered usually by a unknown third party. In addition, it is often necessary to ensure that the document actually originated from the purported sender.

Digital signatures have often been used to ensure integrity of documents with respect to content. A digital signature generally refers to a number (or numbers) generated based on the content, the integrity of which is sought to be ensured. Only the details of digital signatures as relevant to the presented embodiments is described herein. For further details on digital signatures, the reader is referred to a book entitled, “Applied Cryptography 2nd Ed.”, Bruce Schneier, ISBN Number: 0-471-1 1709-9, which is incorporated in its entirety into the present application.

In a first prior approach, a digital signature is generated at a sender's end from a sequence of bits forming an electronic document. In addition to data representing user input, the document contains format and other data, according to an application using which the electronic file is earlier generated. The digital signature is also sent along with the document to a receiver, and the received digital signature can be used to ensure the integrity of the document. The integrity of the user input is also thus ensured.

The above approach has the advantage that signatures can be generated (and verified) without knowledge of the specific user application creating the document. However, one disadvantage with the above approach is that a different stream of bits may represent the same user input. For example, as is typical with some word processing software (e.g., Microsoft Word), when a user retrieves a file, makes a change and reverts back to the pre-change state, the data streams representing the file before the change and after the reversion are not the same (even though logically the user input is the same).

As another example, a user application may be set up to automatically re-format a file when opened with a newer version of the same user application, and the signature generated for a prior version is generally not valid for the file generated for the newer version. That is, even though the user input has not changed, the digital signature could be found to be invalid even though the user input has not changed.

A second prior approach overcomes such a problem by generating digital signatures based on data representing user inputs stored in an electronic file representing a document. As the data representation often does not depend on the user application version changes, the problems with the first prior approach may be overcome, at least in several situations. Unfortunately, the second prior approach requires knowledge of the specific format employed by the user application generating the document, and such may be impractical in some situations.

Accordingly what is needed is a flexible approach which enables the integrity of user input to be verified (ensured) when transmitted in an electronic document.

### SUMMARY OF THE INVENTION

In accordance with the present invention, multiple digital signatures are generated based on the electronic representation of a document. The integrity of the user input can be verified using either or both of the digital signatures. In one embodiment, a first digital signature is generated based on the user input and the second digital signature is generated based on data representing the electronic file.

Thus, a receiving system can ensure the integrity of user data based on either of the digital signatures. If the file contents (i.e., data representation of the file) can change even when the user input effectively does not change, then the receiving system can check the integrity of the user input using the digital signature generated from the user input. On the other hand, if the file contents do not change when the user input does not change, the digital signature generated from the file representation can be used to check the integrity of the data.

The same hash operation can be used to generate all the digital signatures. Also, the electronic document may contain a handwritten biometric signature (user signature), which a sender generally incorporates after completion of providing user input. The electronic file along with the user signature forms an electronic document. An embodiment of the present invention is implemented substantially in the form of software.

According to another aspect of the present invention, a digital signature may be generated for the user input (content) in each portion of an electronic document. A control section may also be maintained to specify audit information (e.g., modification history) and rules associated with each portion. Examples of rules include whether the corresponding portion can be printed or not, whether the portion can be modified further or not, etc.

Further features and advantages of the invention, as well as the structure and operation of various embodiments of the invention, are described in detail below with reference to the accompanying drawings. In the drawings, like reference numbers generally indicate identical, functionally similar, and/or structurally similar elements. The drawing in which an element first appears is indicated by the leftmost digit(s) in the corresponding reference number.

### BRIEF DESCRIPTION OF THE DRAWINGS

The present invention is described with reference to the accompanying drawings, wherein:

FIG. 1 is a block diagram illustrating an example environment in which the present invention can be implemented;

FIG. 2 is a flow chart illustrating a method using which an electronic document can be created and sent in accordance with the present invention;

FIG. 3 is a flow chart illustrating a method using which an electronic document can be received in accordance with the present invention; and

FIG. 4 is a block diagram illustrating the details of implementation of various features of the present invention substantially in the form of software.

### DETAILED DESCRIPTION OF THE PREFERRED EMBODIMENTS

1. Overview and Discussion of the Invention

The present invention allows multiple digital signatures to be generated using different approaches, with each approach generating a digital signature for input data including the user input. All such signatures are transmitted associated with the document. Any/all of the signatures can be used to ensure the integrity of the associated document.

In one embodiment, one digital signature is generated using a sequence of data bits representing a file (storing the desired user input) and another digital signature is generated using data (within the file) representing the user input. The two digital signatures are transmitted associated with the file such that a receiver can ensure that the user input in a received document (file) is not altered after the digital signature has been generated.

According to another aspect of the present invention, a document may contain multiple portions (e.g., pages or sections), and a digital signature may be associated with each portion. A control section may be provided associated with the document, with the control section storing potentially several rules and audit information for each portion of the document.

Example rules include indicating whether the corresponding section can be changed, data can be added later, etc. Actions on corresponding sections may be permitted only consistent with the indicated rules. Audit information may include the date/time the signature was generated, any changes made to the portion, etc. The control section may thus be used to control and manage various portions of a document.

The invention is described below with reference to an example environment for illustration. It should be understood that numerous specific details, relationships, and methods are set forth to provide a full understanding of the invention. One skilled in the relevant art, however, will readily recognize that the invention can be practiced without one or more of the specific details, or with other methods, etc. In other instances, well-known structures or operations are not shown in detail to avoid obscuring the invention. Furthermore the invention can be implemented in several other environments. It is helpful to understand some general concepts to appreciate the described embodiments.

2. General Concepts

Digital signatures are generally generated using a hash operation. The hash operation is performed on input data (the integrity of which is sought to be protected) to generate a string at a sender's end. The string represents the digital signature, and is sent along with the input data to the receiver. The receiver performs the same hash operation on the input data to ensure that the resulting string matches the received string. If there is a match, the input data is deemed not to have been modified. For further details on digital signatures, the reader is referred to a book entitled, “Applied Cryptography 2nd Ed.”, Bruce Schneier, ISBN Number: 0-471-11709-9, which is incorporated in its entirety into the present application.

It may be desirable to have the document ‘signed’ (sender/user signatures) by the sender to comply with various legal requirements. In embodiments described below, biometric signatures are used. In biometric signatures, several of the sender's signature samples are taken, and the corresponding information is made available at the receiver end. The information may be made available in the form of a template, which stores the key characteristics of the samples.

The purported sender also physically signs (“present biometric signature”) in respect of the document (electronic file) being sent. The present signature is compared with the samples (or a template generate from the samples) to provide an indication (for example, as a percentage of match) that the sender is in fact the person who s/he purports to be. For further details on biometric signatures, the reader is referred to the following two documents which are both incorporated in their entirety into the present application:

1. Entitled, “Automatic On-Line Signature Verification” by Vishvjit Nalwa, Proceedings of the IEEE, Vol.85. No.2, February 1997; and

2. “On-Line Recognition of Handwritten Symbols” by Gordon Wilfong, Frank Sinden, and Laurence Ruedisueli, IEEE Transactions on Pattern Analysis and Machine Intelligence, Vol.18, No.9, September 1996.

In addition, it is often desirable to encrypt the data and/or the digital signature such that unknown third parties cannot view or otherwise tamper with the user input. As is well known, encryption may be based on symmetric or asymmetric keys. In a symmetric key based system, a single key is used for encryption and decryption, and thus may not be suitable in many situations as the security of the key may be compromised due to the sharing.

Accordingly, in an asymmetric signatures based system, a key pair is generated based on an authentication scheme (such as a pass-phrase or bio-metric signature). The key pair contains a private key and a public key, which cannot generally be deciphered from each other. However, data encrypted with one key can generally be decrypted only using the other key. The private key is maintained confidential while the public key is freely distributed to the rest of the world. Using the concepts noted above, the manner in which the present invention may be implemented in an example environment is described below.

3. Example Environment

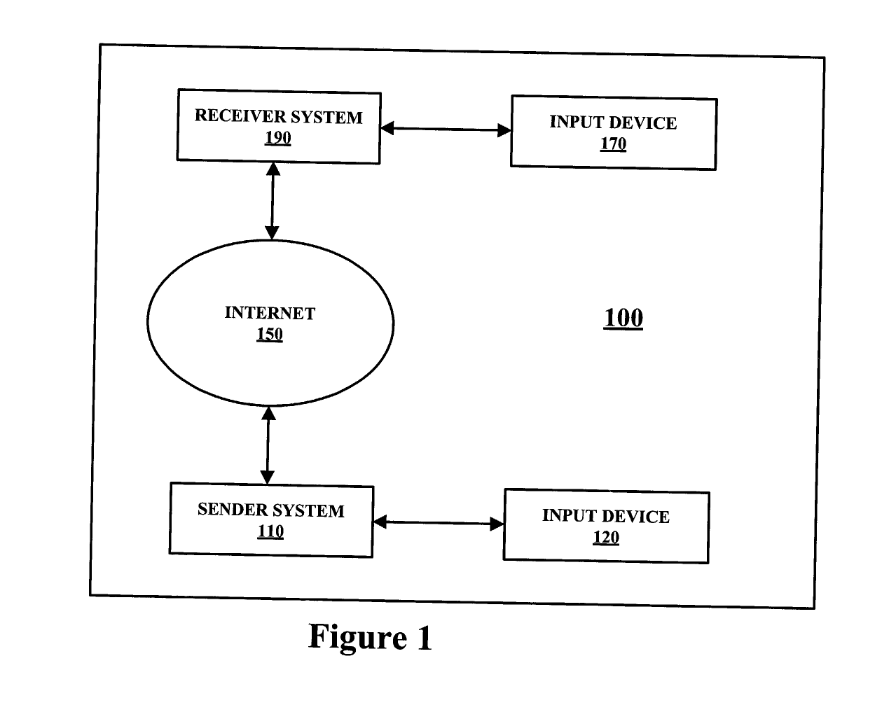

FIG. 1 is a block diagram illustrating an example environment in which the present invention can be implemented. There is shown sender system 110, input devices 120 and 170, Internet 150, and receiving system 190. Internet 150 provides the connectivity between the two systems 110 and 190, enabling a user at receiving system 190 to confirm the integrity of the data received in an electronic document as described below in further detail.

Input device 120 enables a user to enter a biometric signature (one form of user signatures). The data representing the entered user signature may be captured in sender system 110 using application program interfaces (API) such as WINTAB well known in the relevant arts. It should be understood that other forms of signatures (e.g., based on passwords, or patterns on eye-lids) may also be used depending on the implementation of input devices 120 and 190. The manner in which the biometric signature is used is described below.

Sender system 110 enables a user to create and/or modify an electronic file, and thereby incorporate user input into an electronic file (eventually to be a document). The specific user input generally depends on the nature of the eventual document. Thus, in the case of word processing type user applications, the text, format codes, and/or objects provided by the user constitutes user input. In the case of some other user applications (e.g., purchase orders), a template may be provided and the user merely needs to enter the input data corresponding to various fields defined by the template. The data defining at least some of the contents of the template may also be regarded as being part of user input consistent with the implementation of receiving system 190.

Sender system 110 then interfaces with input device 120 to receive a user signature. The user signature can be based on biometric or other forms. The user signature along with the electronic file forms an electronic document. The present invention enables the integrity of the document to be verified as described below in further details.

The user may request sender system 110 to generate digital signatures after completion of entering the user input. Sender system 110 then generates at least two signatures. In an embodiment described below, one signature (referred to as a “first signature” or “file hash” only for convenience) is generated by hashing the all the data bits representing the electronic document and another signature (“second signature” or “content hash”) is generated by hashing the data bits representing the user input in the electronic file. The manner in which the two signatures are generated is described below with reference to an electronic file generated using Microsoft Word. However, the concepts may be applied to other types of electronic documents as well.

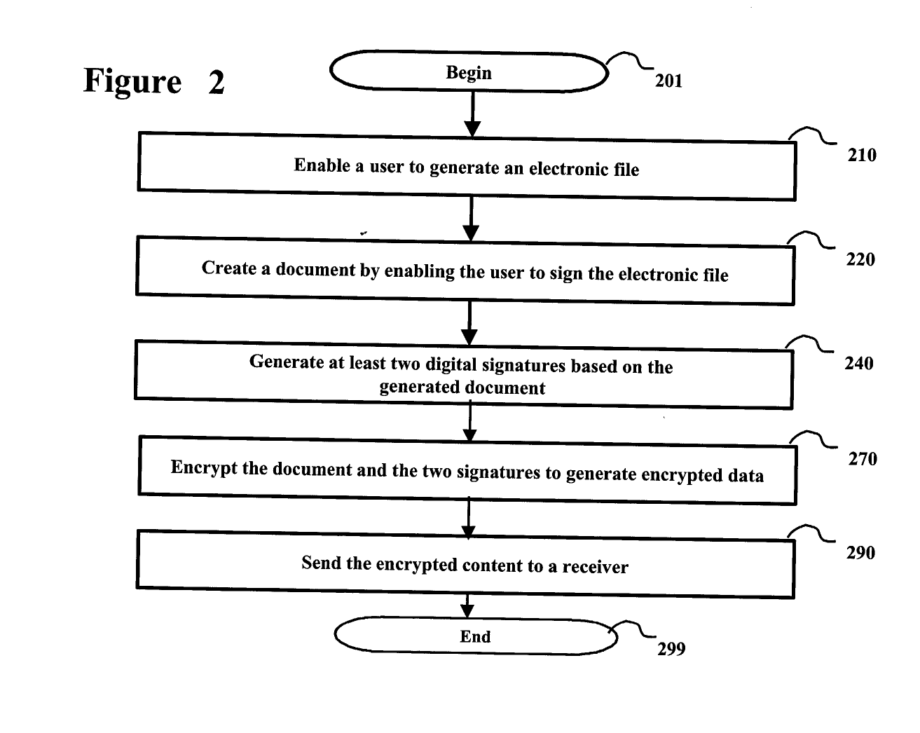

An example sender system 110 may operate in accordance with the flow-chart of FIG. 2. The flow-chart begins in step 201, in which control passes to step 210. In step 210, sender system 110 enables a user to generate (create, edit, and/or modify) an electronic file. In step 220, sender system 110 may enable a user to sign the document. The corresponding signatures is referred to as a user signature. In an embodiment, a biometric signature is received using input device 120 as noted above.

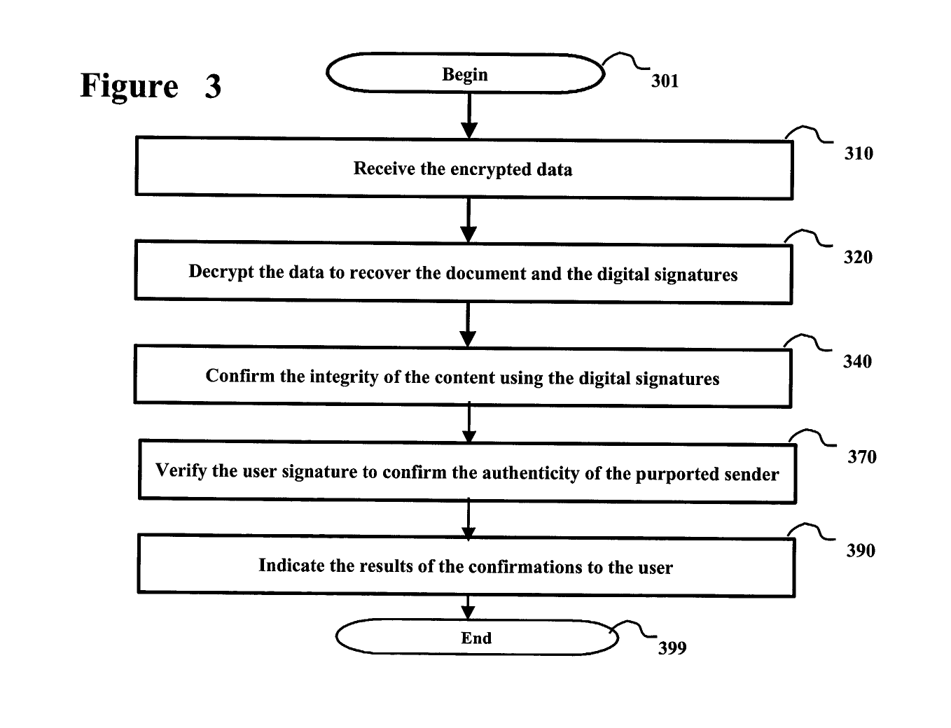

In step 240, sender system 110 generates two signatures, for example, as described above. In step 270, sender system 110 may encrypt the document and the digital signatures. Asymmetric signatures approach (briefly described above) may be used, and the sender's private key may be used for the encryption. The encrypted data is sent to the user over Internet 150 in step 290. The manner in which a receiver system may process the encrypted data is described below with combined reference to FIGS. 1 and 3.

4. Processing Document at the Receiving End

FIG. 3 is a flow chart illustrating a method using the encrypted data of above may be processed. The flow chart starts in step 301, in which control immediately passes to step 310. In step 310, receiver system 190 receives the encrypted data on internet 150, for example, in a known way using protocols such as Internet Protocol. In step 320, the encrypted data is decrypted to recover the documents and the (at least) two digital signatures. The decryption needs to be performed consistent with the encryption approach used at the sending side. The decryption may also be performed in a known way.

In step 340, the integrity of the document is verified using one or both (all) of the digital signatures. The manner in which the digital signatures are used is described below in the context of a document generated by Microsoft's Word document. However, the approach can be used with other types of documents as well.

In step 370, the user signature in the document is verified to confirm the authenticity of the purported sender. When the user signature is a biometric signature, receiver system 190 may receive multiple samples of user signature using input'device 170. A template representing the characteristics of the user signature may be generated and stored in receiver system 190. When a document is received, the signature in the document may be compared against the stored characteristics to determine a percentage of match with the samples. The percentage provides a confidence level as to the authenticity of the purported user.

In step 390, the results of performing steps 320, 340 and 370 are indicated. That is, receiver system 190 indicates whether the document and signatures could be properly decrypted (step 320), whether the document has been modified since generating the digital signatures (as determined in step 340), the extent to which the user signature associated with the received document matches the template signature pre-stored in receiver system 190 (step 370).

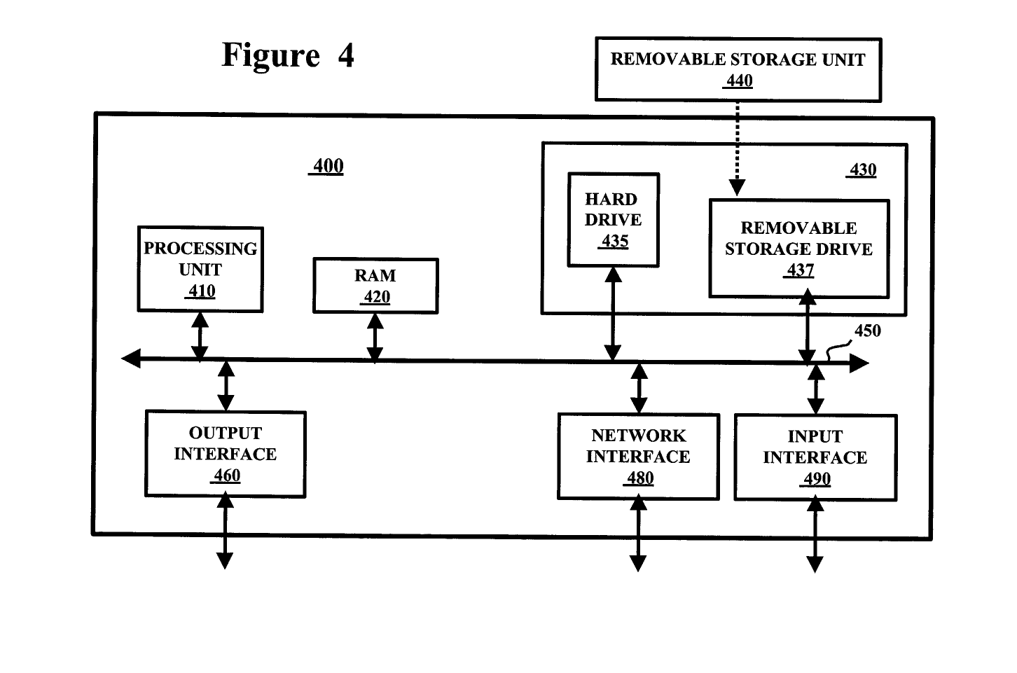

Thus, a receiving party can be certain about the integrity of the document using one or more features of the present invention. An embodiment of sender system 110 and receiver system 190 are implemented using software. Accordingly, a software implementation of either system is described below with reference to FIG. 4.

5. Software Implementation

FIG. 4 is a block diagram illustrating the details of sender system 110 or receiver system 190 (commonly referred to as computer system 400) in one embodiment. System 400 is shown containing processing unit 410, random access memory (RAM) 420, storage 430, output interface 460, network interface 480 and input interface 490. Each component is described in further detail below.

Output interface 460 provides output signals (e.g., display signals to a display unit, not shown) which can form the basis for a suitable user interface for a user to interact with System 400. Input interface 490 (e.g., interface with a key-board and/or mouse, not shown) enables a user to provide any necessary inputs to system 400. Output interface 460 and input interface 490 can be used, for example, by a user to create an electronic file, to initiate input device 120 to receive a user signature, to start generating the multiple digital signatures based on the document, and to start the encryption when system 400 corresponds to sender system 110.

When system 400 corresponds to receiver system 190, output interface 460 and input interface 490 can be used, for example, by a user to cause decryption of received data to recover an electronic document, to cause receiver system 190 to confirm the integrity of the content of the electronic document, and to view the results of various activities when processing a received document. Network interface 480 enables system 400 to send and receive data on communication networks using protocols such as Internet Protocol (IP). Network interface 480, output interface 460 and input interface 490 can be implemented in a known way.

RAM 420 and/or storage 430 maybe referred to as a memory. RAM 430 may receive instructions and data on path 450 from storage 430. Even though shown as one unit, RAM 420 maybe implemented as several units. Secondary memory 430 may contain units such as hard drive 435 and removable storage drive 437. Secondary storage 430 may store the software instructions and data, which enable system 400 to provide several features in accordance with the present invention. The portions of the secondary storage storing the instructions and controlling the operation of system 400 may be referred to as computer program products. The instructions and data stored on the computer program products are readable by computer system 400.

Some or all of the data and instructions (software routines) may be provided on removable storage unit 440, and the data and instructions may be read and provided by removable storage drive 437 to processing unit 410. Floppy drive, magnetic tape drive, CD-ROM drive, DVD Drive, Flash memory, removable memory chip (PCMCIA Card, EPROM) are examples of such removable storage drive 437. Documents generated in accordance with the present invention may be stored in removable storage medium and/or transmitted electronically using network interface 480.

Processing unit 410 may contain one or more processors. In general, processing unit 410 reads sequences of instructions from various types of memory medium (including RAM 420, storage 430 and removable storage unit 440), and executes the instructions to provide various features of the present invention described above. The description is continued with reference to generating digital signatures for electronic files in the context of documents created using Microsoft Word.

6. Generating Digital Signatures for Microsoft Word Documents

As noted above, two signatures may be generated associated with a document. The first digital signature (file hash) may be generated by hashing the data representing the entire document. That is, the data bits representing the document may be hashed to generate the file hash.

With respect to content hash for Microsoft Word document, the following are included in generating the content hash (or second signature) in one embodiment:

Highlighted Text i.e., Text with Font Format as HighLight

Crossed Out Text i.e., Text with Font Format as strikethrough

Double Crossed Out Text i.e., Text with Font Format as double strikethrough (not shown)

Superscripted Text

Text where Background Color is the same as the Font Color

Hidden Text

Positions and sizes of all the drawing Objects on the document

All the remaining Text including Headers, Footers, Footnotes, Endnotes, Comments, Text in Frames (including, Drawing Objects)

If any text contains fields, then those fields may also included as an input to the hash operation generating the content digital signature:

In addition, intrinsic ActiveX objects properties such as TextBox(Text contained in the textbox), ComboBox(All the list items in the combo along with the selected text), ListBox(All the listitems in the combo along with the selected text), OptionButton(Whether selected or not), CheckBox(Whether checked or not), Label(Text on the Label), and CommandButton(Caption of the Button) may also be included in the input (user input) to the hash operation. In general, any information provided by the user may be included in the hash input.

It should be understood that various techniques such as parsing of the document may be employed to determine the various pieces of the user input. In an embodiment implemented to operate with Microsoft Word Documents, utilities referred to as ‘functions/methods’ may be used to retrieve various pieces of user input. In general, each function/method is designed for retrieval of a type of content within a document. Each function/method may be activated while providing a range as a parameter, and all content of the corresponding type present in the range is returned.

Thus, a designer merely needs to determine the different types of content which are to be included in the user input (used for generating the content signature), and the corresponding functions/methods are invoked specifying the electronic file as the range. Thus, one function/method may be used to retrieve all high-lighted text and another function may be used to retrieve all hidden text.

In general, a designer needs to generally determine which portions of a electronic document are to be incorporated as user input, retrieve the corresponding content from the document, and generate a content hash (digital signature) for the user input. The file hash and content hash together are transmitted so that the one or both the signatures can be used to ensure the integrity of the document.

7. Digital Signatures for Portions

While the embodiments of above are described with reference to generating a single digital signature for the entire user input in a document, it should be understood that a different digital signature may be associated with the user input in different portions of a document. For example, with reference to Microsoft Word documents, each document may potentially contain multiple sections. Each section may be viewed as a portion of the document.

According to an aspect of the present invention, a digital signature is generated for the user input in each portion (section in the case of Microsoft Word). Thus, a recipient may determine the integrity of each section, in addition to the integrity of the entire document using the corresponding digital signatures. In general, sender system 110 and receiver system 190 need to be implemented consistently to recognize various features of the present invention.

8. Controlling Different Portions of a Document Differently

According to an aspect of the present invention, a control section is included in each document. The control portion stores the digital signatures for each portion of the document. In addition, audit information and rules may also be stored associated with each portion of the document. Audit information may include information on when the document was last modified, who modified the document, when the digital signature was generated, etc.

Examples of rules include whether the corresponding portion can be printed, modified, etc. The rules can be used to control the acts permitted/prohibited on the corresponding section. Thus, if a rule indicates that the corresponding portion of the document cannot be modified, receiver system 190 may prevent someone from printing the portion. Similarly, if a rule specifies that the portion cannot be modified, both sender system 110 and receiver system 190 may prevent further modification of that portion of the document.

Thus, using the features provided by the present invention, a receiving party can ensure the integrity of documents (or portions thereof).

9. Conclusion

While various embodiments of the present invention have been described above, it should be understood that they have been presented by way of example only, and not limitation. Thus, the breadth and scope of the present invention should not be limited by any of the above-described exemplary embodiments, but should be defined only in accordance with the following claims and their equivalents.

What is claimed is:

1. A method implemented in a computer system for enabling a sender to send documents, said method comprising:
enabling said sender generate an electronic file containing an user input;
generating a first digital signature based on a first data containing said user input;
generating a second digital signature based on second data containing said user input, wherein said second data is different from said first data; and
sending said first digital signature and said second digital signature to a receiver system,
wherein said receiver system verifies the integrity of said user input by using one of both of said first digital signature and said second digital signature.

2. The method of claim 1, wherein said first data comprises said user input only, and wherein said second data comprises an electronic file containing said user input.

3. The method of claim 2, wherein said second data further comprises a user signature, and said electronic file comprises an electronic document.

4. The method of claim 3, wherein said first digital signature and second digital signature are generated using the same hash operation.

5. The method of claim 3, wherein said user signature comprises a biometric signature.

6. The method of claim 5, wherein said biometric signature comprises a handwritten signature of said sender.

7. The method of claim 3, further comprising encrypting said electronic file, said first and second digital signatures and said user signature to generate encrypted data, wherein said encrypted data is examined by said receiver system to verify the integrity of said user input.

8. The method of claim 7, wherein said encrypted data is sent to said receiver system on either Internet or a dial-up connection.

9. The method of claim 3, further comprising generating a plurality of content digital signatures, wherein each of said plurality of content digital signatures is based on user input contained in a portion of said electronic document.

10. The method of claim 9, further comprising storing a control section associated with said electronic document, wherein said control section includes audit information associated with at least one of said plurality of content digital signatures.

11. The method of claim 9, further comprising storing a control section associated with said electronic document, wherein said control section includes a rule associated with at least one of said plurality of content digital signatures, wherein said rule specifies an action either permitted or prohibited against the corresponding section.

12. The method of claim 11, wherein said action comprises one of whether the corresponding section can be printed or not, and whether the corresponding section can be modified or not.

13. A method implemented in a computer system for enabling a receiver to receive electronic documents, said method comprising:
receiving a first data containing a user input and at least a first digital signature and a second digital signature, wherein said first digital signature and said second digital signature are generated based on data containing said user input; and
examining said first signature and/or second signature to determine the integrity of said user input.

14. The method of claim 13, wherein said first data further contains a user signature and said user input is contained in an electronic document.

15. The method of claim 14, wherein said first signature is generated based on said user input only and wherein said second signature is generated based on said electronic document.

16. A method of generating electronic documents, said method comprising:
enabling a user to generate an electronic document comprising a plurality of portions;
enabling said user to specify a rule associated with each of said plurality of portions;
generating a digital signature associated with each of said plurality of portions;
including a control section in said electronic document, wherein said control section specifies said rules associated with the corresponding portions.

17. A computer system for enabling a sender to send documents, said computer system comprising:
means for enabling said sender generate an electronic file containing an user input;
means for generating a first digital signature based on a first data containing said user input;
means for generating a second digital signature based on second data containing said user input, wherein said second data is different from said first data; and
means for sending said first digital signature and said second digital signature to a receiver system,
wherein said receiver system verifies the integrity of said user input by using one of both of said first digital signature and said second digital signature.

18. A computer system for enabling a receiver to receive electronic documents, said computer system comprising:
means for receiving a first data containing a user input and at least a first digital signature and a second digital signature, wherein said first digital signature and said second digital signature are generated based on data containing said user input; and
means for examining said first signature and/or second signature to determine the integrity of said user input.

19. A computer readable medium carrying one or more sequences of instructions for causing for enabling a sender to send documents, wherein execution of said one or more sequences of instructions by one or more processors contained in said device causes said one or more processors to perform the actions of:
enabling said sender generate an electronic file containing an user input;
generating a first digital signature based on a first data containing said user input;
generating a second digital signature based on second data containing said user input, wherein said second data is different from said first data; and
sending said first digital signature and said second digital signature to a receiver system,
wherein said receiver system verifies the integrity of said user input by using one of both of said first digital signature and said second digital signature.
